(19) United States
(12) Patent Application Publication
(10) Pub. No.: US 2024/0003627 A1
(43) Pub. Date: Jan. 4, 2024

(54) HEATING FURNACE

(71) Applicant: NGK INSULATORS, LTD., Nagoya-City (JP)

(72) Inventors: Daniel Yukichi KITAGUCHI, Inazawa-Shi (JP); Tatsuya KINOSHITA, Kasugai-Shi (JP); Masami SATO, Nagoya-Shi (JP)

(73) Assignee: NGK INSULATORS, LTD., Nagoya-City (JP)

(21) Appl. No.: 18/331,256

(22) Filed: Jun. 8, 2023

(30) Foreign Application Priority Data
Jun. 29, 2022 (JP) 2022-105027

(51) Int. Cl. F27B 9/12; F27D 9/00; F28C 3/00

(52) U.S. Cl. CPC F27B 9/12; F27D 9/00; F28C 3/005; F27B 2009/126; F27D 2009/0075

(57) ABSTRACT

A heating furnace includes a plurality of heat storage coolers capable of introducing a cooling gas into an inside of the furnace and sucking an in-furnace gas; wherein each of the plurality of heat storage coolers includes a gas nozzle in communication with the inside of the furnace; a gas port in communication with an outside of the furnace and connected to a gas piping system that is capable of switching between supplying gas to the heat storage cooler and exhausting gas from the heat storage cooler; a gas passage communicating the gas nozzle with the gas port and having a space for filling a heat storage element; and a heat storage element filled in the space for filling the heat storage element.

### CROSS REFERENCE TO RELATED APPLICATIONS

The present invention claims the benefit of priority to Japanese Patent Application No. 2022-105027 filed on Jun. 29, 2022 with the Japanese Patent Office, the entire contents of which are incorporated herein by reference in its entirety.

### FIELD OF THE INVENTION

The present invention relates to a heating furnace, and in particular, to a firing furnace.

### BACKGROUND OF THE INVENTION

Firing furnaces for firing ceramic products such as roof tiles, sanitary ware, tableware, and honeycomb structures (for example, filters and heat exchangers) include batch-type and continuous-type firing furnaces. In either case, after the workpiece is heat-treated, it is necessary to cool the workpiece.

As a method for cooling the workpiece, a direct cooling method in which the air outside the furnace is injected directly into the furnace as a cooling gas for heat exchange with the workpiece is common (for example, Japanese Patent No. 2859987, Japanese Patent Application Publication No. H04-124586). A cooling method in which an indirect cooler is used in addition to the direct cooling is also known for the purpose of improving the heat recovery efficiency and improving the controllability of heat curve (for example, Japanese Patent Examined Publication No. H03-40317). Japanese Patent Application Publication No. 2020-29988).

### PRIOR ART

### Patent Literature

[Patent Literature 1] Japanese Patent No. 2859987
[Patent Literature 2] Japanese Patent Application Publication No. H04-124586
[Patent Literature 3] Japanese Patent Examined Publication No. H03-40317
[Patent Literature 4] Japanese Patent Application Publication No. 2020-29988

### SUMMARY OF THE INVENTION

There is an optimum heat curve for performing desired heat treatment on a workpiece according to the specifications of the workpiece. Therefore, the operating conditions of the heating furnace are usually set so as to obtain such an optimum heat curve. Direct cooling and indirect cooling as described above are known for cooling a workpiece, but the following problems remain.

In the case of direct cooling, a necessary amount of cooling gas is supplied into the furnace to obtain a desired heat curve, but it is difficult to finely control the temperature of the cooling gas supplied into the furnace. For this reason, a large deviation often occurs between the temperature of the cooling gas supplied into the furnace and the temperature of the in-furnace gas. In particular, in direct cooling, the surface of the workpiece passing a position close to the supply port of the cooling gas is rapidly cooled, which is likely to result in the occurrence of cracks. In addition, in the case of direct cooling, especially in a continuous heating furnace, if the amount of cooling gas is changed, the furnace pressure in the cooling zone is likely to fluctuate, and the gas flow in the furnace may be disturbed.

In addition, since indirect cooling has poorer cooling capacity than direct cooling, there is a problem that it is difficult for indirect cooling alone to control the heat curve in the furnace. In addition, since indirect cooling does not have the ability to stir the in-furnace gas, the temperature distribution of the in-furnace gas tends to occur. In particular, in the case of a continuous heating furnace, the gas temperature in the furnace is likely to have a distribution in the cross-section perpendicular to the direction in which the workpiece travels. For this reason, a difference in cooling rate is likely to occur between a workpiece near the indirect cooler and a workpiece distant from the indirect cooler. If an attempt is made to optimize the cooling rate of the workpiece distant from the indirect cooler, the workpiece close to the indirect cooler may be cooled excessively and cracks may even occur. On the other hand, if an attempt is made to optimize the cooling rate of the workpiece close to the indirect cooler, heat removal from the workpiece distant from the indirect cooler tends to be insufficient.

Therefore, in the conventional methods, either direct cooling or indirect cooling, there are problems in terms of crack suppression of the workpiece during cooling and uniformity of the gas temperature distribution in the furnace (for a continuous heating furnace, it means the uniformity of the gas temperature distribution in the furnace in the cross-section perpendicular to the direction in which the workpieces travel). The present invention has been created in view of the above circumstances. In an embodiment, it is an object to provide a heating furnace capable of reducing the risk of cracks occurring in a workpiece during cooling and contributing to improving the uniformity of the gas temperature distribution in the furnace during cooling.

In order to solve the above problems, the inventors of the present invention have made intensive studies, and have found that, by using a heat storage cooler with a predetermined structure, it is possible to supply cooling gas into the furnace with less deviation from the temperature of the in-furnace gas when a cooling process is carried out. The present invention has been completed based on this finding, and is exemplified as below.

[1] A heating furnace, comprising a plurality of heat storage coolers capable of introducing a cooling gas into an inside of the furnace and sucking an in-furnace gas;
wherein each of the plurality of heat storage coolers comprises a gas nozzle in communication with the inside of the furnace; a gas port in communication with an outside of the furnace and connected to a gas piping system that is capable of switching between supplying gas to the heat storage cooler and exhausting gas from the heat storage cooler; a gas passage communicating the gas nozzle with the gas port and having a space for filling a heat storage element; and a heat storage element filled in the space for filling the heat storage element.

[2] The heating furnace according to [1], wherein the heating furnace is a continuous heating furnace comprising an inlet, a heating zone, a cooling zone, and an outlet in this order, for heat treating at least one workpiece while transporting the at least one workpiece from the inlet to the outlet in the furnace, and
the cooling zone comprises the plurality of heat storage coolers.

[3] The heating furnace according to [1] or [2], wherein at least one heat storage cooler of the plurality of heat storage coolers comprises at least one inlet/outlet for exchanging the heat storage element.

[4] The heating furnace according to [3], wherein at least one heat storage cooler of the plurality of heat storage coolers comprises:
the gas passage comprising a first gas passage extending horizontally from the gas nozzle, and a second gas passage communicating the space for filling the heat storage element located below the first gas passage with the first gas passage;
a first inlet/outlet for exchanging the heat storage element provided above the second gas passage; and
a communication passage communicating the first inlet/outlet with the second gas passage.

[5] The heating furnace according to [3] or [4], wherein at least one heat storage cooler of the plurality of heat storage coolers comprises a second inlet/outlet for exchanging the heat storage element, in communication with a lower portion of the space for filling the heat storage element.

[6] The heating furnace according to any one of [1] to [5], wherein the heat storage element is in a form of balls, honeycombs or meshes.

[7] The heating furnace according to [1] or [2], wherein at least one of the plurality of heat storage coolers comprises the gas nozzle on a first inner wall, and at least one of the plurality of heat storage coolers comprises the gas nozzle on a second inner wall facing the first inner wall.

[8] The heating furnace according to [7], satisfying one or both of the following conditions (1) and (2):
(1) at least one of the plurality of heat storage coolers comprises the gas nozzle at above half a height of the first inner wall, and at least one of the plurality of heat storage coolers comprises the gas nozzle at below half a height of the second inner wall,
(2) at least one of the plurality of heat storage coolers comprises the gas nozzle at above half the height of the second inner wall, and at least one of the plurality of heat storage coolers comprises the gas nozzle at below half the height of the first inner wall.

[9] The heating furnace according to [7] or [8], wherein a number of the heat storage coolers comprising the gas nozzle on the first inner wall and a number of the heat storage coolers comprising the gas nozzle on the second inner wall are the same.

[10] The heating furnace according to any one of [7] to [9], wherein at least one heat storage cooler comprising the gas nozzle on the first inner wall and at least one heat storage cooler comprising the gas nozzle on the second inner wall are configured to be contrary regarding a timing of introducing the cooling gas into the furnace and a timing of sucking the in-furnace gas.

[11] The heating furnace according to [2], or any one of [3] to [10] depending from [2], wherein the cooling zone comprises one or more cooling gas supply ports capable of introducing the cooling gas into the furnace on a side even closer to the outlet than the heat storage cooler closest to the outlet among the plurality of heat storage coolers; each of the one or more cooling gas supply ports is in communication with the gas port of at least one of the plurality of heat storage coolers, and is configured such that an exhaust gas from the at least one heat storage cooler can be introduced into the furnace via the cooling gas supply port as the cooling gas.

[12] The heating furnace according to [11], wherein the cooling zone comprises one or more out-of-furnace air inlets in communication with the outside of the furnace on a side even closer to the outlet than the cooling gas supply port closest to the outlet among the one or more cooling gas supply ports.

[13] The heating furnace according to any one of [1] to [12], wherein the heating furnace is a firing furnace.

According to the continuous heating furnace of the present invention, cooling gas preheated by the heat storage cooler, which has a heat storage function, can be supplied into the furnace. Therefore, it is possible to supply a cooling gas, which has less deviation from the gas temperature in the furnace, into the furnace, thereby reducing the risk of cracks occurring in the workpiece due to rapid cooling of the workpiece. The use of a heat storage cooler also contributes to energy saving since no particular energy is required to heat the cooling gas. In addition, since the cooling gas supplied into the furnace from the gas nozzle of the heat storage cooler has a velocity, it has the effect of agitating the in-furnace gas. Therefore, it contributes to improving the uniformity of the gas temperature distribution in the furnace during cooling.

### BRIEF DESCRIPTION OF THE DRAWINGS

FIG. 1 is a schematic side view showing a configuration example of a heat storage cooler according to an embodiment of the present invention.

FIG. 2 is a schematic side view showing an example of the overall configuration of a continuous heating furnace according to an embodiment of the present invention.

FIG. 3 is a schematic plan view showing a configuration example of a cooling zone of a continuous heating furnace according to an embodiment of the present invention.

FIG. 4 shows an exemplary cross-sectional schematic view of the cooling zone of the continuous heating furnace according to an embodiment of the present invention when the cross-section perpendicular to the workpiece traveling direction is viewed from the rear; as well as an exemplary schematic diagram of a gas piping system 400.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

<1. Heat Storage Cooler>

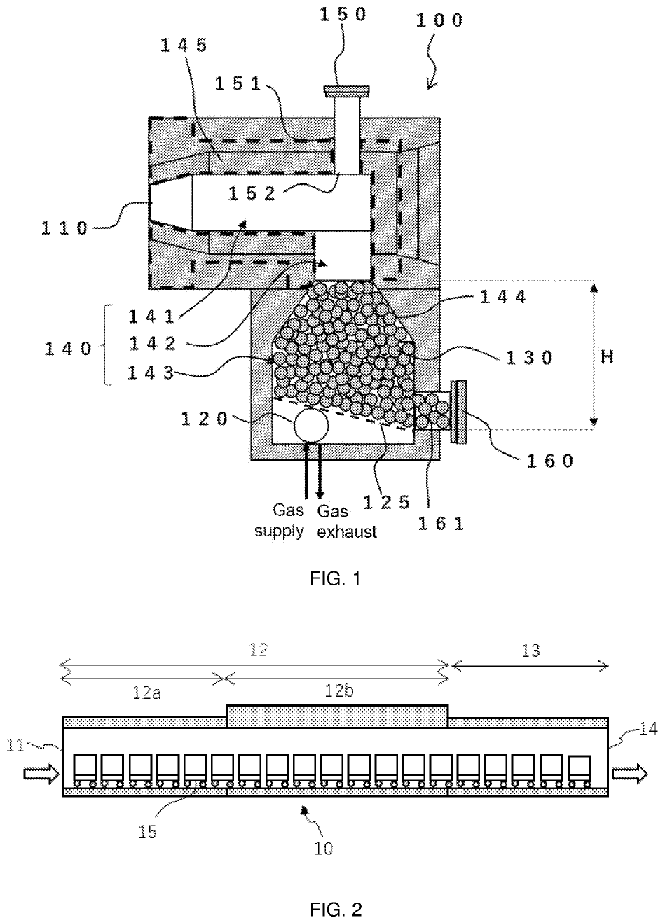

FIG. 1 shows a schematic diagram showing a configuration example of a heat storage cooler 100 according to an embodiment of the present invention. The heat storage cooler 100 comprises a gas nozzle 110 in communication with the inside of the furnace; a gas port 120 in communication with the outside of the furnace and connected to a gas piping system that is capable of switching between supplying gas to the heat storage cooler 100 and exhausting gas from the heat storage cooler 100; a gas passage 140 communicating the gas nozzle 110 with the gas port 120 and having a space 143 for filling a heat storage element 130; and a heat storage element 130 filled in the space 143 for filling the heat storage element 130.

The gas passage 140 is configured such that the cooling gas supplied from the gas port 120 passes through the space 143 filled with the heat storage element 130, and then is introduced into the furnace from the gas nozzle 110. Further, the gas passage 140 is configured such that the in-furnace gas sucked from the gas nozzle 110 passes through the space 143 filled with the heat storage element 130, and then is discharged out of the furnace through the gas port 120.

Therefore, when the in-furnace gas is supplied from the gas nozzle 110 to the gas passage 140, the in-furnace gas is cooled by exchanging heat with the heat storage element 130. After cooling, the in-furnace gas is discharged from the gas port 120 to the outside of the furnace. On the other hand, the heat storage element 130 that has exchanged heat with the in-furnace gas is heated. After that, when the gas supply/exhaust is switched and the cooling gas is supplied from the gas port 120 into the gas passage 140, the cooling gas is heated by exchanging heat with the heat storage element 130. Then, the cooling gas after heating is supplied from the gas nozzle 110 into the furnace. This allows the temperature of the cooling gas supplied into the furnace from the heat storage cooler 100 to approach the temperature of the in-furnace gas.

As a method of raising the temperature of the cooling gas supplied from the heat storage cooler 100 into the furnace and reducing the temperature difference from the in-furnace gas, for example, it is conceivable to lengthen the time for exhausting to raise the temperature of the heat storage element or increase the filling amount of the heat storage element. Conversely, as a method of lowering the temperature of the cooling gas supplied from the heat storage cooler 100 into the furnace thereby increasing the cooling capacity, for example, it is conceivable to shorten the time for exhausting to suppress the temperature rise of the heat storage element, or to reduce the filling amount of the heat storage element. In this way, with the heat storage cooler 100, the temperature of the in-furnace gas can be adjusted by a method other than the method of changing the flow rate of the cooling gas. Therefore, particularly in a continuous heating furnace, there is an advantage that even if the heat curve in the cooling zone is adjusted, the influence on the furnace pressure in the cooling zone is small, and the gas flow in the furnace can be easily stabilized.

Although not limited to, for example, the temperature of the cooling gas supplied into the furnace from the gas nozzle 110 of the heat storage cooler 100 immediately before it is discharged from the gas nozzle 110 is preferably about 50 to 400° C. lower than the average temperature of the in-furnace gas, in the case of a batch-type heating furnace (in the case of a continuous heating furnace, the average temperature of the in-furnace gas in the cooling zone where the heat storage cooler 100 is installed). In addition, the temperature of the exhaust gas discharged from the gas port 120 of the heat storage cooler 100 immediately before it is discharged from the gas port 120 is preferably 110° C. or higher, more preferably 150° C. or higher, in order to prevent condensation. The temperature is preferably 350° C. or lower, more preferably 300° C. or lower, in order to protect the facility. Therefore, the temperature is, for example, preferably 110 to 350° C., more preferably 150 to 300° C.

The heat storage element 130 is not particularly limited, but can be provided in the form of balls, honeycombs, or meshes. The material of the heat storage element 130 may be appropriately selected in consideration of corrosion resistance and heat resistance, and for example, it can be made of ceramics or metal, and preferably, an optimum one can be selected from ceramics such as SiC-based materials, alumina, cordierite, mullite, and aluminum titanate.

Air is generally used as the cooling gas, but the cooling gas is not limited to air. For example, inert gases such as N₂ and Ar may be used alone or in combination of two or more.

In order to prevent the heat storage element 130 from entering the gas port 120, it is preferable to separate the gas port 120 and the heat storage element 130 with a gas-permeable separator 125. In this case, separator 125 constitutes the bottom of the space 143 for filling the heat storage element 130. As the separator 125, for example, a metal (for example, SUS) grid structure or punching plate can be used.

As the gas supply and exhaust are repeated, dust/impurity accumulates around the heat storage element 130. If this accumulated dust/impurity is discharged into the furnace for some reason, and adheres to the workpiece being transported, it may cause a discoloration defect. For this reason, it is preferable that the heat storage cooler 100 is provided with at least one inlet/outlet port 150, 160 for exchanging the heat storage element so that the heat storage element 130 can be easily exchanged.

In an embodiment, the gas passage 140 comprises a first gas passage 141 extending horizontally from the gas nozzle 110 and a second gas passage 142 communicating the space 143 for filling the heat storage element 130 located below the first gas passage 141 with the first gas passage 141. The second gas passage 142 preferably extends in a vertical direction. In addition, for the purpose of making the heat storage cooler compact while ensuring heat insulation, the space 143 for filling the heat storage element 130 preferably comprises a tapered portion 144 in which the passage becomes narrower as it approaches the second gas passage 142. Here, the “horizontal direction” in the present specification is a concept including not only the direction strictly perpendicular to the direction of gravity but also substantially horizontal directions. Substantially horizontal directions include directions within 20° of the strictly horizontal direction. In addition, the “vertical direction” used in the present specification is a concept that includes not only a direction strictly parallel to the direction of gravity, but also substantially vertical directions. Substantially vertical directions include directions within 20° from the strictly vertical direction.

The heat storage cooler 100 comprising the first gas passage 141 and the second gas passage 142 may comprise a first inlet/outlet 150 for exchanging the heat storage element provided above the second gas passage 142, and a communication passage 151 communicating the first inlet/outlet 150 with the second gas passage 142. The heat storage element 130 introduced from the first inlet/outlet 150 can fall through the communication passage 151 due to gravity and be accommodated in the space 143 via the second gas passage 142. The first inlet/outlet 150 may be provided above the second gas passage 142 and above the first gas passage 141. In this case, the communication passage 151 can communicate the first inlet/outlet 150 with an opening 152 provided in the first gas passage 141, and the first inlet/outlet 150 is in communication with the second gas passage 142 via the first gas passage 141. The first inlet/outlet 150 can be suitably used for refilling the heat storage element 130, and may also be used for taking out the heat storage element 130.

In addition, in an embodiment, the heat storage cooler 100 may comprise a second inlet/outlet 160 for exchanging the heat storage element, which is in communication with the lower portion of the space 143 for filling the heat storage element 130. The heat storage cooler 100 according to this embodiment may comprises a communication passage 161 that communicates the lower portion of the space 143 with the second inlet/outlet 160. The “lower portion” of the space 143 means a portion located at a position lower than half the height H from the lowest position to the highest position of the heat storage element 130 filled in the space 143 (before a removal operation). The second inlet/outlet 160 is preferably installed at a position that allows access to the heat storage element 130 filled in the bottom of the space 143. At this time, if the separator 125 is inclined downward toward the communicating passage 161, the heat storage element 130 filled in the space 143 naturally moves to the second inlet/outlet 160 via the communicating passage 161 by gravity. Therefore, the heat storage element 130 can be easily taken out. The second inlet/outlet 160 can be suitably used for taking out the heat storage element 130, and may also be used for refilling the heat storage element 130.

The wall 145 that partitions the gas passage 140 is preferably made of a ceramic material such as alumina, mullite, or magnesia from the viewpoint of heat resistance, thermal shock resistance, abrasion resistance, and the like. In particular, the surfaces of the first gas passage 141 and the second gas passage 142, which come into contact with high-temperature gas, are preferably composed of bricks containing at least the above-described ceramic material. In the heat storage cooler 100 according to the embodiment shown in FIG. 1, the portions made of bricks are surrounded by dotted lines. In the heat storage cooler 100 according to the embodiment shown in FIG. 1, other parts where heat resistance is required are made of a castable (monolithic refractory) or a fiber board containing the ceramic material.

In an embodiment, the gas port 120 is in communication with a gas supply fan via a pipe, so that a cooling gas such as cooling air can be supplied to the heat storage cooler 100 from the gas supply fan. In addition, the gas port 120 is in communication with an exhaust gas fan via a pipe, so that the exhaust gas from the heat storage cooler 100 can be transported to the exhaust gas fan. Supplying cooling gas to the heat storage cooler 100 and exhausting gas from the heat storage cooler 100 can be switched, for example, by operating a valve installed on the way of the pipes.

<2. Continuous Heating Furnace>

FIG. 2 is a schematic side view showing an example of the overall configuration of the continuous heating furnace 10 including the heat storage cooler according to the embodiment described above. The continuous heating furnace 10 comprises an inlet 11, a heating zone 12, a cooling zone 13 and an outlet 14 in this order, and it can heat-treat a workpiece (not shown) loaded on a carriage 15 while transporting the workpiece from the inlet 11 toward the outlet 14 within the furnace.

The heating zone refers to the range in the direction in which the workpiece travels from the inlet of the continuous heating furnace to a heating device installed closest to the outlet among the heating devices for heating the interior of the furnace. The cooling zone refers to the range in the direction in which the workpiece travels from immediately after the heating device installed closest to the outlet to the outlet of the continuous furnace. The concept of “heating” includes “firing”. When manufacturing a ceramic product, the heating zone 12 can be divided into a preheating zone 12a in which binder removal is performed and a firing zone 12b in which firing is performed.

The workpiece is an article that undergoes heat treatment and should not be particularly limited, and examples include electronic parts such as ferrite and ceramic capacitors, semiconductor products, ceramic products, pottery, oxide refractories, glass products, metal products, and carbon-based refractories such as alumina-graphite and magnesia-graphite. The continuous heating furnace according to the present embodiment can be suitably used when heating a workpiece to 1000° C. or higher, typically 1200° C. or higher, more typically 1400° C. or higher, and for example, 1000 to 2000° C.

There are no particular restrictions on the type of the continuous heating furnace. For example, tunnel kilns, roller hearth kilns and pusher kilns can be used. Further, the continuous heating furnace is typically an atmospheric firing furnace, and is normally operated without intentionally lowering the oxygen concentration, except for the reduction in the oxygen concentration in the furnace due to burner combustion.

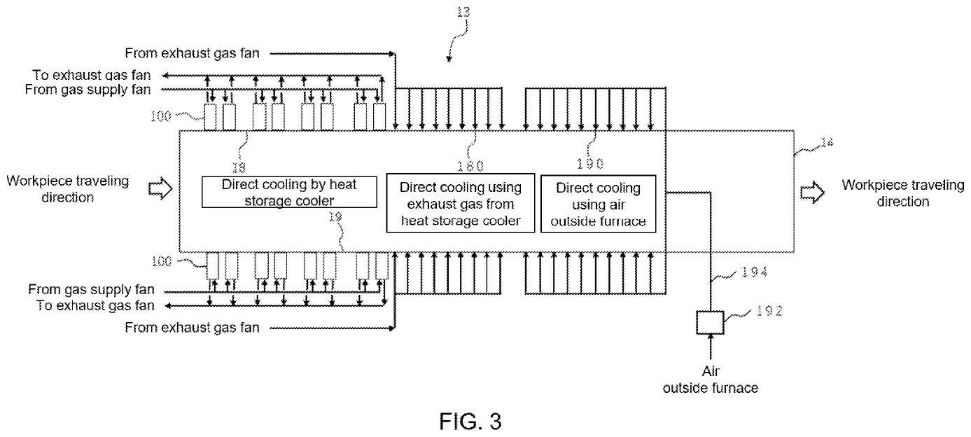

FIG. 3 shows a schematic plan view showing a configuration example of the cooling zone 13. The cooling zone 13 comprises a plurality of heat storage coolers 100 according to the above-described embodiments, which is capable of introducing the cooling gas supplied from the gas supply fan into the inside of the furnace, and exhausting the in-furnace gas to the exhaust gas fan. Although not limited to, the plurality of heat storage coolers 100 can be installed on the furnace wall at the cooling zone 13 where the average temperature of the in-furnace gas is in the range of 1400° C. to 400° C., for example.

At least one of the plurality of heat storage coolers 100 comprises a gas nozzle 110 provided on the furnace wall 18 (the first inner wall) on the left side with respect to the direction in which the workpiece travels, and at least one of the plurality of heat storage coolers 100 comprises a gas nozzle 110 provided on the furnace wall 19 (the second inner wall) on the right side with respect to the direction in which the workpiece travels. In a preferred embodiment, a plurality of heat storage coolers 100 comprises gas nozzles 110 provided on the furnace wall 18 (the first inner wall) on the left side with respect to the direction in which the workpiece travels, and a plurality of heat storage coolers 100 comprises gas nozzles 110 provided on the furnace wall 19 (the second inner wall) on the right side with the direction in which the workpiece travels. The number of heat storage coolers 100 comprising gas nozzles 110 on the left furnace wall 18 (the first inner wall) with respect to the direction in which the workpiece travels, and the number of heat storage coolers 100 comprising gas nozzles 110 on the furnace wall 19 (the second inner wall) on the right side with respect to the direction in which the workpiece travels, may be appropriately set in consideration of the cooling rate, furnace length/width, amount of heat to be removed, and the like. For example, they can be installed at intervals of 3 to 10 m with respect to the direction in which the workpiece travels.

In order to improve the uniformity of the gas temperature distribution in the furnace in the cross-section perpendicular to the direction in which the workpiece travels, it is preferable that the number of heat storage coolers 100 comprising gas nozzles 110 on the furnace wall 18 (the first inner wall) on the left side with respect to the direction in which the workpiece travels, and the number of heat storage coolers 100 comprising gas nozzles 110 on the furnace wall 19 (the second inner wall) on the right side with respect to the direction in which the workpiece travels are set the same. In addition, in order to improve the uniformity of the gas temperature distribution in the furnace in the cross-section perpendicular to the direction in which the workpiece travels, it is also preferable to set the installation locations along the direction in which the workpiece travels of the plurality of heat storage coolers 100 comprising gas nozzles 110 on the furnace wall 18 (the first inner wall) on the left side with respect to the direction in which the workpiece travels, to be the same as the installation locations along the direction in which the workpiece travels of the plurality of heat storage coolers 100 comprising gas nozzles 110 on the furnace wall 19 (the second inner wall) on the right side with respect to the direction in which the workpiece travels.

In an embodiment, at least one, preferably a number of 50% or more, more preferably a number of 80% or more, and even more preferably all of the heat storage coolers 100 comprising the gas nozzle 110 on the furnace wall 18 (the first inner wall) on the left side, and at least one, preferably a number of 50% or more, more preferably a number of 80% or more, and even more preferably all of the heat storage coolers 100 comprising the gas nozzle 110 on the furnace wall 19 (the second inner wall) on the right side are configured to be contrary regarding the timing of introducing the cooling gas into the furnace and the timing of sucking the in-furnace gas. According to this configuration, for example, when the cooling gas is introduced into the furnace from the at least one heat storage cooler 100 comprising the gas nozzle 110 on the furnace wall 18 (the first inner wall) on the left side, the cooling gas traverses the furnace in the right-left direction. After that, it is sucked by the at least one heat storage cooler 100 comprising the gas nozzle 110 on the furnace wall 19 (the second inner wall) on the right side. As a result, the cooling gas is more likely to diffuse horizontally and vertically in the cross-section perpendicular to the direction in which the workpiece travels in the furnace, contributing to improved uniformity of the gas temperature distribution in the furnace in the cross-section perpendicular to the direction in which the workpiece travels.

The in-furnace gas sucked from the heat storage cooler 100 is sent to the exhaust gas fan by the suction force of the exhaust gas fan. Although the exhaust gas from the exhaust gas fan may be discharged to the atmosphere, it is advantageous from the viewpoint of energy saving to reuse it for cooling the workpieces downstream with lower temperatures. Therefore, in an embodiment, the cooling zone 13 comprises one or more cooling gas supply ports 180 capable of introducing the cooling gas from at least one heat storage cooler 100 into the furnace on the side closer to the outlet 14, and preferably only on the side closer to the outlet 14, than the heat storage cooler 100 closest to the outlet 14 among the plurality of heat storage coolers 100. Each of the one or more cooling gas supply ports 180 is in communication with the gas port 120 of at least one heat storage cooler 100 of the plurality of heat storage coolers 100 via the exhaust gas fan, and is configured such that the exhaust gas from the at least one heat storage cooler 100 can be introduced into the furnace via the cooling gas supply port 180 as the cooling gas. Although not limited, the one or more cooling gas supply ports 180 can be located on the furnace wall at the cooling zone 13 where the average furnace gas temperature is in the range of, for example, 150° C. to 600° C. The temperature of the cooling gas supplied into the furnace from the cooling gas supply port 180 immediately before it is discharged from the cooling gas supply port 180 is preferably about 50 to 250° C. lower than the average temperature of the in-furnace gas in the cooling zone 13 where the cooling gas supply port 180 is installed.

The cooling zone 13 may comprise one or more out-of-furnace air inlets 190 communicating with the outside of the furnace on the side closer to the outlet 14, and preferably only on the side closer to the outlet 14, than the cooling gas supply port 180 closest to the outlet 14 among the one or more cooling gas supply ports 180. The out-of-furnace air (typically ambient air) may be sucked by one or more fans 192 and may be supplied into the inside of the furnace through the pipe (such as a duct) 194. The air entering the furnace from the out-of-furnace air inlet 190 can be used to directly cool the workpiece. Although not limited to, the one or more out-of-furnace air inlets 190 can be installed at the cooling zone where the average temperature of the in-furnace gas is in the range of, for example, 50° C. to 300° C. When the in-furnace gas temperature is within such a temperature range, the temperature of the workpiece is sufficiently low, and even if the workpiece is directly cooled using out-of-furnace air, there is almost no risk of cracks. The temperature of the air supplied into the furnace from the out-of-furnace air inlet 190 immediately before it is discharged from the out-of-furnace air inlet 190 is preferably about 50 to 200° C. lower than the average temperature of the in-furnace gas in the cooling zone 13 where the out-of-furnace air inlet 190 is installed.

In order to improve the uniformity of the furnace gas temperature distribution in the cross-section perpendicular to the direction in which the workpiece travels, it is also advantageous to enhance the ability to agitate the furnace gas. Therefore, in a preferred embodiment, the plurality of heat storage coolers 100 are arranged such that one or both of the following conditions (1) and (2) are satisfied.
(1) at least one of the plurality of heat storage coolers 100 comprises the gas nozzle 110 at above half the height of the furnace wall 18 (the first inner wall) on the left side in the direction in which the workpiece travels, and at least one of the plurality of heat storage coolers 100 comprises the gas nozzle 110 at below half the height of the furnace wall 19 (the second inner wall) on the right side in the direction in which the workpiece travels.
(2) at least one of the plurality of heat storage coolers 100 comprises the gas nozzle 110 at above half the height of the furnace wall 19 (the second inner wall) on the right side in the direction in which the workpiece travels, and at least one of the plurality of heat storage coolers 100 comprises the gas nozzle 110 at below half the height of the furnace wall 18 (the first inner wall) on the left side in the direction in which the workpiece travels.

In a preferred embodiment, in addition to one or both of the conditions (1) and (2), the cooling gas is introduced into the furnace such that one or both of the following conditions (3) and (4) are further satisfied.
(3) at least one, preferably a number of 50% or more, more preferably a number of 80% or more, and even more preferably all of the heat storage coolers 100 comprising the gas nozzle 110 at above half the height of the furnace wall 18 (the first inner wall) on the left side, and at least one, preferably a number of 50% or more, more preferably a number of 80% or more, and even more preferably all of the heat storage coolers 100 comprising the gas nozzle 110 at below half the height of the furnace wall 19 (the second inner wall) on the right side are configured to be contrary regarding the timing of introducing the cooling gas into the furnace and the timing of sucking the in-furnace gas.
(4) at least one, preferably a number of 50% or more, more preferably a number of 80% or more, and even more preferably all of the heat storage coolers 100 comprising the gas nozzle 110 at above half the height of the furnace wall 19 (the second inner wall) on the right side, and at least one, preferably a number of 50% or more, more preferably a number of 80% or more, and even more preferably all of the heat storage coolers 100 comprising the gas nozzle 110 at below half the height of the furnace wall 18 (the first inner wall) on the left side are configured to be contrary regarding the timing of introducing the cooling gas into the furnace and the timing of sucking the in-furnace gas.

According to this configuration, the cooling gas can easily flow not only in the horizontal direction but also in the vertical direction within the furnace, which further contributes to improving the uniformity of the in-furnace gas temperature distribution in the cross-section perpendicular to the direction in which the workpiece travels.

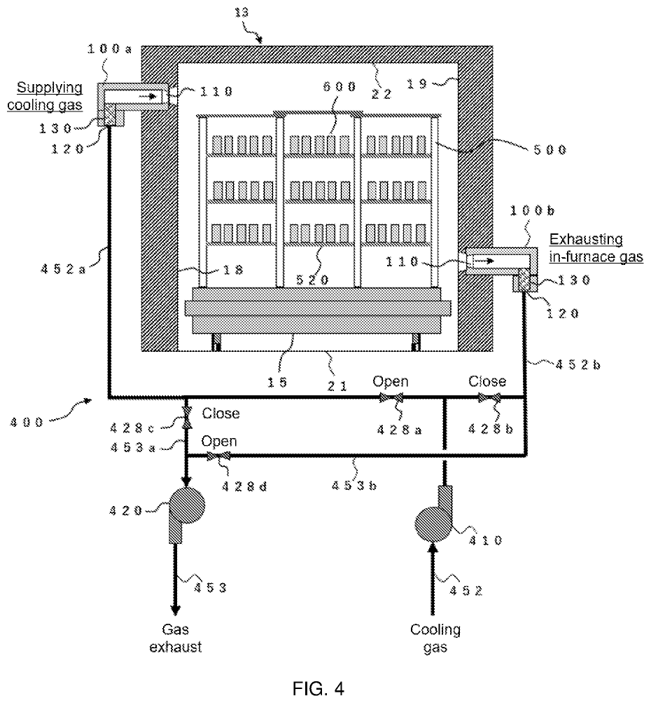

FIG. 4 shows an exemplary cross-sectional schematic view of the cooling zone of a continuous heating furnace when viewed from the rear in the direction in which the workpiece 600 travels; as well as an exemplary schematic diagram of a gas piping system 400. The continuous heating furnace comprises at least one first heat storage cooler 100a comprising a gas nozzle 110 at above half the height of the furnace wall 18 (the first inner wall) on the left side with respect to the direction in which the workpiece 600 travels; and at least one second heat storage cooler 100b comprising a gas nozzle 110 at below half the height of the furnace wall 19 (second inner wall) on the right side with respect to the direction in which the workpiece 600 travels. In addition, the half the height of the furnace wall (the first inner wall or the second inner wall) means a half of the height from the furnace bottom 21 to the ceiling 22 along the furnace wall (the first inner wall or the second inner wall) at the location where the first heat storage cooler 100a or the second heat storage cooler 100b is installed.

A large number of workpieces 600 can be loaded on a plurality of shelf boards 520 installed on the kiln tool 500 placed on the carriage 15.

A gas supply fan 410 is installed on the way of a pipe 452 through which a cooling gas such as out-of-furnace air flows. The pipe 452 branches downstream of the gas supply fan 410 into a pipe 452a connected to the gas port 120 of the first heat storage cooler 100a and a pipe 452b connected to the gas port 120 of the second heat storage cooler 100b. Gas supply valves 428a and 428b are provided on the way of the pipes 452a and 452b, respectively. Further, the pipe 452a is branched to the pipe 453a on the way, and the pipe 452b is branched to the pipe 453b on the way. Exhaust gas valves 428c and 428d are provided on the way of the pipes 453a and 453b, respectively. The pipes 453a and 453b join the pipe 453 downstream of the exhaust gas valves 428c and 428d. An exhaust gas fan 420 is installed on the way of the pipe 453.

FIG. 4 shows a gas supply mode in which the cooling gas is supplied into the furnace from the first heat storage cooler 100a, and an exhaust gas mode in which the in-furnace gas is exhausted from the second heat storage cooler 100b. Periodically, switching between supplying gas and exhausting gas is performed between the first heat storage cooler 100a and the second heat storage cooler 100b. Due to the switching, the first heat storage cooler 100a that was previously in the gas supply mode turns to the exhaust gas mode, and the second heat storage cooler 100b that was previously in the exhaust gas mode turns to the gas supply mode. This switching can be performed by reversing the opening/closing states of the gas supply valves 428a, 428b and the exhaust gas valves 428c, 428d. Switching between supplying gas and exhausting gas can be repeated at predetermined time intervals, and the predetermined time can be, for example, 10 seconds to 300 seconds.

In FIG. 4, although two-way valves are shown as gas supply valves 428a, 428b and exhaust gas valves 428c, 428d, three-way valves may also be used. An electrically driven valve such as a solenoid valve can be used as the valve. Further, in FIG. 4, a state in which one first heat storage cooler 100a and one second heat storage cooler 100b are installed is shown, but it is preferable to arrange a plurality of first heat storage coolers 100a and a plurality of second heat storage coolers 100b in parallel in the direction in which the workpiece travels. For example, by branching the pipe 452a and arranging the plurality of first heat storage coolers 100a in parallel, it is possible to collectively switch the gas supply and exhaust with respect to the plurality of first heat storage coolers 100a. Similarly, by branching the pipe 452b and arranging the plurality of second heat storage coolers 100b in parallel, it is possible to collectively switch the gas supply and exhaust to and from the plurality of second heat storage coolers 100b. Alternatively, pipes for exhausting gas and pipes for supplying gas may be prepared independently and connected to the gas port 120, respectively.

In the above embodiment, a continuous heating furnace was described, but the mechanism is the same in a batch heating furnace and it will be understood that providing the heat storage coolers has the advantage of reducing the risk of cracks occurring in the workpiece and the advantage of improving the uniformity of the gas temperature distribution in the furnace.

### DESCRIPTION OF REFERENCE NUMERALS

110: Continuous heating furnace
11: Inlet
12: Heating zone
12a: Preheating zone
12b: Firing zone
13: Cooling zone
14: Outlet
15: Carriage
18: Furnace wall (first inner wall)
19: Furnace wall (second inner wall)
21: Furnace bottom
22: Ceiling
100: Heat storage cooler
100a: First heat storage cooler
100b: Second heat storage cooler
110: Gas nozzle
120: Gas port
125: Separator
130: Heat storage element
140: Gas passage
141: First gas passage
142: Second gas passage
143: Space
144: Tapered portion
145: Wall
150: First inlet/outlet
151: Communication passage
152: Opening
160: Second inlet/outlet
161: Communication passage
180: Cooling gas supply port
190: Out-of-furnace air inlet
192: Fan
194: Pipe
400: Gas piping system
410: Gas supply fan
420: Exhaust gas fan
428a: Gas supply valve
428b: Gas supply valve
428c: Exhaust gas valve
428d: Exhaust gas valve
452: Pipe
452a: Pipe
452b: Pipe
453: Pipe
453a: Pipe
453b: Pipe
500: Kiln tools
520: Shelf board
600: Workpiece

1. A heating furnace, comprising a plurality of heat storage coolers capable of introducing a cooling gas into an inside of the furnace and sucking an in-furnace gas;
wherein each of the plurality of heat storage coolers comprises a gas nozzle in communication with the inside of the furnace; a gas port in communication with an outside of the furnace and connected to a gas piping system that is capable of switching between supplying gas to the heat storage cooler and exhausting gas from the heat storage cooler; a gas passage communicating the gas nozzle with the gas port and having a space for filling a heat storage element; and a heat storage element filled in the space for filling the heat storage element.

2. The heating furnace according to claim 1, wherein the heating furnace is a continuous heating furnace comprising an inlet, a heating zone, a cooling zone, and an outlet in this order, for heat treating at least one workpiece while transporting the at least one workpiece from the inlet to the outlet in the furnace, and
the cooling zone comprises the plurality of heat storage coolers.

3. The heating furnace according to claim 1, wherein at least one heat storage cooler of the plurality of heat storage coolers comprises at least one inlet/outlet for exchanging the heat storage element.

4. The heating furnace according to claim 3, wherein at least one heat storage cooler of the plurality of heat storage coolers comprises:
the gas passage comprising a first gas passage extending horizontally from the gas nozzle, and a second gas passage communicating the space for filling the heat storage element located below the first gas passage with the first gas passage;
a first inlet/outlet for exchanging the heat storage element provided above the second gas passage; and
a communication passage communicating the first inlet/outlet with the second gas passage.

5. The heating furnace according to claim 3, wherein at least one heat storage cooler of the plurality of heat storage coolers comprises a second inlet/outlet for exchanging the heat storage element, in communication with a lower portion of the space for filling the heat storage element.

6. The heating furnace according to claim 1, wherein the heat storage element is in a form of balls, honeycombs or meshes.

7. The heating furnace according to claim 1, wherein at least one of the plurality of heat storage coolers comprises the gas nozzle on a first inner wall, and at least one of the plurality of heat storage coolers comprises the gas nozzle on a second inner wall facing the first inner wall.

8. The heating furnace according to claim 7, satisfying one or both of the following conditions (1) and (2):
(1) at least one of the plurality of heat storage coolers comprises the gas nozzle at above half a height of the first inner wall, and at least one of the plurality of heat storage coolers comprises the gas nozzle at below half a height of the second inner wall,
(2) at least one of the plurality of heat storage coolers comprises the gas nozzle at above half the height of the second inner wall, and at least one of the plurality of heat storage coolers comprises the gas nozzle at below half the height of the first inner wall.

9. The heating furnace according to claim 7, wherein a number of the heat storage coolers comprising the gas nozzle on the first inner wall and a number of the heat storage coolers comprising the gas nozzle on the second inner wall are the same.

10. The heating furnace according to claim 7, wherein at least one heat storage cooler comprising the gas nozzle on the first inner wall and at least one heat storage cooler comprising the gas nozzle on the second inner wall are configured to be contrary regarding a timing of introducing the cooling gas into the furnace and a timing of sucking the in-furnace gas.

11. The heating furnace according to claim 2, wherein the cooling zone comprises one or more cooling gas supply ports capable of introducing the cooling gas into the furnace on a side even closer to the outlet than the heat storage cooler closest to the outlet among the plurality of heat storage coolers; each of the one or more cooling gas supply ports is in communication with the gas port of at least one of the plurality of heat storage coolers, and is configured such that an exhaust gas from the at least one heat storage cooler can be introduced into the furnace via the cooling gas supply port as the cooling gas.

12. The heating furnace according to claim 11, wherein the cooling zone comprises one or more out-of-furnace air inlets in communication with the outside of the furnace on a side even closer to the outlet than the cooling gas supply port closest to the outlet among the one or more cooling gas supply ports.

13. The heating furnace according to claim 1, wherein the heating furnace is a firing furnace.
